(19) United States
(12) Patent Application Publication
(10) Pub. No.: US 2023/0287295 A1
(43) Pub. Date: Sep. 14, 2023

(54) PROCESS FOR PRODUCING CHLORIDE DEPLETED FEEDSTOCK FROM CHLORIDE CONTAINING CRUDE OIL OR FAT FEEDSTOCK

(71) Applicant: L'Air Liquide Société Anonyme pour l'Etude et l'Exploitation des Procédés Georges Claude, Paris (FR)

(72) Inventors: Bruno CAPELLO, Frankfurt am Main (DE); Mrityunjoy SAMADDAR, Frankfurt am Main (DE)

(21) Appl. No.: 18/121,303

(22) Filed: Mar. 14, 2023

(30) Foreign Application Priority Data
Mar. 14, 2022 (EP) 22020109.9

(51) Int. Cl. C11B 3/06; C10L 1/02; C11B 3/04

(52) U.S. Cl. CPC C11B 3/06; C10L 1/02; C11B 3/04; C10L 2200/0484; C10L 2290/544

(57) ABSTRACT

A process for producing a chloride depleted feedstock from a chloride containing crude oil or fat feedstock is provided. The process including the following steps: providing the chloride containing crude oil or fat feedstock; contacting the chloride containing crude oil or fat feedstock with at least one degumming agent under degumming conditions to obtain a degummed feedstock; contacting the degummed feedstock with at least one first chloride removal agent under first chloride removal conditions to obtain a first dechlorinated feedstock; contacting the first dechlorinated feedstock with at least one bleaching agent under bleaching conditions to obtain a bleached feedstock; contacting the bleached feedstock with at least one second chloride removal agent under second chloride removal conditions to obtain a chloride depleted feedstock; and routing out the chloride depleted feedstock from a second chloride removal step.

### CROSS REFERENCE TO RELATED APPLICATIONS

This application claims the benefit of priority under 35 U.S.C. § 119 (a) and (b) to European Patent Application No. 22020109.9, filed Mar. 14, 2022, the entire contents of which are incorporated herein by reference.

### TECHNICAL FIELD

The present disclosure relates generally to feedstock pretreatment process; more specifically, the present disclosure relates to a process and an apparatus for producing a chloride depleted feedstock from a chloride containing crude oil or fat feedstock.

### BACKGROUND

Hydrocracking or hydrotreating of natural and waste oils and fats, also known as “HVO” (hydrotreating vegetable oils) process, is used for generating renewable diesel, renewable jet fuel, renewable naphtha and renewable liquefied petroleum gas (LPG), Crude natural and waste oils and fats are typical feedstocks for a HVO plant which need to be cleaned or refined, using a HVO pretreatment process, before subjecting to the HVO plant in order to ensure a proper functioning of the HVO plant.

Since the crude oils, used cooking oils or animal fats (e.g. tallow) usually have a high amount of chloride compounds typically in a range of 100 to 350 weight (wt.)-parts per million (ppm) of total chlorides, while organic chlorides vary from 10 to 100 wt.-ppm. Removal of chloride components is a crucial attribute of the HVO pretreatment process, especially in order to protect apparatus parts against chloride induced stress corrosion cracking in downstream units in addition to other operational advantages in the HVO plant. The maximum chlorides content allowed in the HVO inlet feed is typically in a range of between 1 and 50 wt.-ppm or between 1 and 10 wt.-ppm depending on a material of construction of the HVO plant.

Existing approaches for oil pretreatment are usually through a chemical and/or a physical refining process. The basic HVO pretreatment solution covers degumming, bleaching and filtration. Optional pretreatment solutions such as polyethylene (PE) removal, free fatty acid (FFA) stripping and oil splitting may be added on a case-by-case basis. Details of such oil pretreatment processes are known from the prior art, e.g. from Ullmann's Encyclopedia of Industrial Chemistry, Sixth Edition, 1998 Electronic Release, FATS AND FATTY OILS—Chapter 6: Refining (Alfred Thomas).

Among various pretreatment processes (e.g., acid-degumming, water-degumming, bleaching and filtration, polyethylene removal, and oil-splitting unit etc.), specifically the water-degumming process removes the chlorides as well as partially some other impurities such as phosphorus and gums from the natural and waste oils and fats.

The water-degumming process removes mainly the inorganic chloride compounds that are soluble in water. Organic chlorides, however, are not removed in the water-degumming process and typically not removed, at least not to the extent desired, in the downstream bleaching and filtration section either, leading to the possibility of these organic compounds being carried with the feedstock to the HVO process. Remaining chlorides in the treated feedstock creates a risk for chloride induced stress corrosion cracking on the effluent part of the HVO plant.

Further, the water-degumming process has a considerable consumption of water that makes recycling systems an essential point to avoid high effluent rates. The remaining impurities in the washed water such as chlorides, however, restricts the recycling rate of washed water so that the effluent or wastewater of the HVO pretreatment process remains a concern.

Therefore, there is a need to address aforementioned technical drawbacks in existing known technologies in removing chlorides from a chloride containing feedstock for HVO process.

### Summary

The present disclosure seeks to provide an improved approach for removing chloride compounds, including organic chloride compounds, from a chloride containing crude oil or fat feedstock. An aim of the present disclosure is to provide a solution that overcomes, at least partially, the problems encountered in the prior art and provide a process and an apparatus which involve a two-step chloride removal process as part of an overall oil pretreatment or refining process steps that produce the chloride depleted feedstock for the production of renewable fuels. The object of the present disclosure is achieved by the solutions provided in the enclosed independent claims. Advantageous implementations of the present disclosure are further defined in the enclosed dependent claims.

According to a first aspect, the present disclosure provides a process for producing a chloride depleted feedstock from a chloride containing crude oil or fat feedstock, the process comprising the following steps:
(a) providing the chloride containing crude oil or fat feedstock;
(b) subjecting the chloride containing crude oil or fat feedstock to a degumming step to obtain a degummed feedstock by contacting the chloride containing crude oil or fat feedstock with at least one degumming agent under degumming conditions;
(c) subjecting the degummed feedstock to a first chloride removal step to obtain a first dechlorinated feedstock by contacting the degummed feedstock with at least one first chloride removal agent under first chloride removal conditions;
(d) subjecting the first dechlorinated feedstock to a bleaching step to obtain a bleached feedstock by contacting the first dechlorinated feedstock with at least one bleaching agent under bleaching conditions;
(e) subjecting the bleached feedstock to a second chloride removal step to obtain a chloride depleted feedstock by contacting the bleached feedstock with at least one second chloride removal agent under second chloride removal conditions; and
(f) routing out the chloride depleted feedstock from the second chloride removal step.

The process for producing the chloride depleted feedstock according to the present disclosure is of advantage in that a minimum of 90% of total chloride compounds including organic chlorides are removed from the chloride containing crude oil or fat feedstock by virtue of the first chloride removal step and the second chloride removal step. Accordingly, the process significantly mitigates the risk of chloride induced stress corrosion cracking in downstream of a hydrotreating vegetable oils (HVO) plant. Further, the process reduces investment costs due to high-grade construction material, like stainless steel or nickel-based alloys, for the HVO plant or part of internals, as the high-grade construction material is required for the HVO plant to process the feedstocks with high chloride content.

According to a second aspect, the present disclosure provides a use of the chloride depleted feedstock as feedstock for a hydrotreatment of vegetable oils or fats to obtain a hydrotreated vegetable oil (HVO) or fat product.

The use of the chloride depleted feedstock as feedstock to obtain the HVO or fat product according to the present disclosure is of advantage in that a minimum of 90% total chloride contents including organic chloride compounds are removed. The chloride depleted feedstock after such a comprehensive total chloride removal may significantly reduce the risk of chloride induced stress corrosion cracking in downstream of a HVO plant and consequently a demand for high grade materials for the construction of the HVO plant.

According to a third aspect, the present disclosure provides an apparatus for producing a chloride depleted feedstock from a chloride containing crude oil or fat feedstock, wherein the apparatus comprises:
(a) means for providing the chloride containing crude oil or fat feedstock;
(b) means for subjecting the chloride containing crude oil or fat feedstock to a degumming step to obtain a degummed feedstock by contacting the chloride containing crude oil or fat feedstock with at least one degumming agent under degumming conditions;
(c) means for subjecting the degummed feedstock to a first chloride removal step to obtain a first dechlorinated feedstock by contacting the degummed feedstock with at least one first chloride removal agent under first chloride removal conditions;
(d) means for subjecting the first dechlorinated feedstock to a bleaching step to obtain a bleached feedstock by contacting the first dechlorinated feedstock with at least one bleaching agent under bleaching conditions;
(e) means for subjecting the bleached feedstock to a second chloride removal step to obtain a chloride depleted feedstock by contacting the bleached feedstock with at least one second chloride removal agent under second chloride removal conditions; and
(f) means for routing out he chloride depleted feedstock from the second chloride removal step.

The apparatus for producing the chloride depleted feedstock according to the present disclosure is of advantage in that a minimum of 90% of total chloride compounds including organic chlorides are removed from the chloride containing crude oil or fat feedstock by virtue of the first chloride removal step and the second chloride removal step. Accordingly, the apparatus significantly alleviates the risk of chloride induced stress corrosion cracking in downstream of a hydrotreating vegetable oils (HVO) plant. Further, the apparatus reduces investment costs due to high-grade construction material, like stainless steel or nickel-based alloys, for the HVO plant or part of internals, as the high-grade construction material is required for the HVO plant to process the feedstocks with high chloride content.

Embodiments of the present disclosure eliminate the aforementioned drawbacks in existing known approaches for removing chlorides from the chloride containing feedstock for production of renewable fuels. The advantage of the embodiments according to the present disclosure in that the embodiments alleviate the risk of chloride induced stress corrosion cracking in downstream of the HVO plant and reduce the demand for the high-grade material for constructing the HVO plant or part of internals.

Additional aspects, advantages, features and objects of the present disclosure are made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. To illustrate the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, the same elements have been indicated by identical numbers. Embodiments of the present disclosure will now be described, by way of example only, with reference to the following diagrams wherein:

FIG. 1 is a block diagram of an apparatus for producing a chloride depleted feedstock from a chloride containing crude oil or fat feedstock according to an embodiment of the present disclosure; and

FIG. 2A is a flowchart illustrating a method for producing a chloride depleted feedstock from a chloride containing crude oil or fat feedstock according to an embodiment of the present disclosure.

FIG. 2B is a flowchart illustrating a method for producing a chloride depleted feedstock from a chloride containing crude oil or fat feedstock according to an embodiment of the present disclosure.

### DETAILED DESCRIPTION OF THE PREFERRED EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

As used herein, several terms are defined below:

The term “chloride depleted feedstock” is to be understood as meaning a feedstock that is free of chlorides including organic chloride compounds after subjecting to pretreatment process steps.

The term “chloride containing crude oil or fat feedstock” is to be understood as meaning a feedstock that usually have a high amount of chloride compounds before subjecting to pretreatment process steps.

The term “degumming step” is to be understood as meaning a pretreatment process step that involves at least partial or full removal of gums, resins, proteins, phosphorus-containing compounds and other impurities from the crude oil or fat feedstock.

The term “degummed feedstock” is to be understood as meaning a refined feedstock that is depleted in gums, resins, proteins, phosphorus-containing compounds and other impurities by the degumming step.

The term “degumming agent” is to be understood as meaning any agent such as physical, chemical, or biological agent used in the degumming step to remove the gums, resins, proteins, phosphorus-containing compounds and other impurities from the feedstock.

The term “degumming conditions” is to be understood as meaning process conditions such temperature, pressure, pH etc. under such conditions the degumming step is performed.

The term “first chloride removal step” is to be understood as meaning a pretreatment process step that involves at least partial removal of chlorides from the crude oil or fat feedstock.

The term “first dechlorinated feedstock” is to be understood as meaning a refined feedstock that is at least partially depleted in chloride contents by the first chloride removal step.

The term “first chloride removal agent” is to be understood as meaning any agent such as physical, chemical, or biological agent used in the first chloride removal step to remove the chlorides from the crude oil or fat feedstock.

The term “first chloride removal conditions” is to be understood as meaning process conditions such temperature, pressure, pH etc. under such conditions the first chloride removal step is performed.

The term “bleaching step” is to be understood as meaning a pretreatment process step that involves at least partial or full removal of pigments, metals, and phosphorus-containing compounds from the crude oil or fat feedstock.

The term “bleached feedstock” is to be understood as meaning a refined feedstock that is at least partially or fully depleted in pigments, metals, and phosphorus-containing compounds by bleaching step.

The term “bleaching agent” is to be understood as meaning any agent such as physical, chemical, or biological agent used in the bleaching step to remove the pigments, metals, and phosphorus-containing compounds from the crude oil or fat feedstock.

The term “second chloride removal step” is to be understood as meaning a pretreatment process step that involves removal of total chlorides (at least 90%) including organic chlorides from the crude oil or fat feedstock.

The term “chloride depleted feedstock” is to be understood as meaning a refined feedstock that is depleted in total chloride contents (at least 90%) including organic chlorides by the second chloride removal step.

The term “second chloride removal agent” is to be understood as meaning any agent such as physical, chemical, or biological agent used in the second chloride removal step to remove the chlorides from the crude oil or fat feedstock.

The term “second chloride removal conditions” is to be understood as meaning process conditions such temperature, pressure, pH etc. under such conditions the second chloride removal step is performed.

The term “polyethylene removal step” is to be understood as meaning a pretreatment process step that involves removal of polyethylene from the crude oil or fat feedstock.

The term “polyethylene removal conditions” is to be understood as meaning process conditions such temperature, pressure, pH etc. under such conditions the polyethylene removal step is performed.

The term “polyethylene depleted feedstock” is to be understood as meaning a refined feedstock that is depleted in polyethylene by the polyethylene removal step.

The term “free fatty acid (FFA) removal step” is to be understood as meaning a pretreatment process step that involves removal of free fatty acid from the crude oil or fat feedstock.

The term “free fatty acid (FFA) removal conditions” is to be understood as meaning process conditions such temperature, pressure, pH etc. under such conditions the free fatty acid (FFA) removal step is performed.

The term “free fatty acid depleted feedstock” is to be understood as meaning a refined feedstock that is depleted in free fatty acid (FFA) by the free fatty acid (FFA) removal step.

The term “oil splitting step” is to be understood as meaning a pretreatment process step that involves hydrolyzing or splitting the triglycerides in the crude oil or fat feedstock into fatty acids and glycerine.

The term “oil splitting conditions” is to be understood as meaning process conditions such temperature, pressure, pH etc. under such conditions the oil splitting step is performed.

The term “oil split feedstock” is to be understood as meaning a refined feedstock where the triglycerides hydrolyzed into fatty acids and glycerine and removed from the crude oil or fat feedstock.

For the purposes of this specification, the liquid hourly space velocity (LHSV) is defined as a ratio of liquid volume flow per hour to reactor volume.

A means is to be understood as meaning something that enables or is helpful in the achievement of a goal. In particular, means for performing a particular process step are to be understood as including all physical articles that would be considered by a person skilled in the art in order to be able to perform this process step. For example, a person skilled in the art will consider means of introducing or discharging a material stream to include all transporting and conveying apparatuses, i.e., for example pipe-lines, pumps, compressors, valves, which seem necessary or sensible to said skilled person for performance of this process step on the basis of his knowledge of the art.

Optional or optionally means that the subsequently described event or circumstances may or may not occur. The description includes instances where the event or circumstance occurs and instances where it does not occur.

“Providing” in a claim is defined to mean furnishing, supplying, making available, or preparing something. The step may be performed by any actor in the absence of express language in the claim to the contrary.

Pressure indications are in bar, absolute, bar(a) or bare for short, unless otherwise stated in the particular context.

According to a first aspect, the present disclosure provides a process for producing a chloride depleted feedstock from a chloride containing crude oil or fat feedstock, the process comprising the following steps:
(a) providing the chloride containing crude oil or fat feedstock;
(b) subjecting the chloride containing crude oil or fat feedstock to a degumming step to obtain a degummed feedstock by contacting the chloride containing crude oil or fat feedstock with at least one degumming agent under degumming conditions;
(c) subjecting the degummed feedstock to a first chloride removal step to obtain a first dechlorinated feedstock by contacting the degummed feedstock with at least one first chloride removal agent under first chloride removal conditions;
(d) subjecting the first dechlorinated feedstock to a bleaching step to obtain a bleached feedstock by contacting the first dechlorinated feedstock with at least one bleaching agent under bleaching conditions;
(e) subjecting the bleached feedstock to a second chloride removal step to obtain a chloride depleted feedstock by contacting the bleached feedstock with at least one second chloride removal agent under second chloride removal conditions; and
(f) routing out the chloride depleted feedstock from the second chloride removal step.

The process for producing the chloride depleted feedstock according to the present disclosure is of advantage in that a minimum of 90% of total chloride compounds including organic chlorides are removed from the chloride containing crude oil or fat feedstock by virtue of the first chloride removal step and the second chloride removal step. Accordingly, the process significantly mitigates the risk of chloride induced stress corrosion cracking in downstream of a hydrotreating vegetable oils (HVO) plant, thereby reducing operational expenditure (OpEX) of the HVO plant. Further, the process reduces investment costs due to high-grade construction material, like stainless steel or nickel-based alloys, for the HVO plant or part of internals, as the high-grade construction material is required for the HVO plant to process the feedstocks with high chloride content.

Optionally, the chloride containing crude oil or fat feedstock comprises at least one element selected from the group comprising: natural oils and fats, waste oils and fats, pretreated oils and fats, cooking oil, tallow, palm oil mill effluent, palm oil fatty acid distillate, or tall oil.

Optionally, the degumming agent comprises at least one element selected from the group comprising: an acid agent, preferably citric and/or phosphoric acid; or a basic agent, preferably caustic soda; or water.

The degumming step may include, but not limited to, at least one of water degumming, acid degumming, alkali degumming, enzymatic degumming, and/or thermal degumming.

Optionally, the first chloride removal agent comprises at least one element selected from the group comprising: an acid agent, preferably citric and/or phosphoric acid; a basic agent, preferably caustic soda; or water.

Optionally, the first chloride removal conditions comprise:
contacting the degummed feedstock with a mixture of water and an acid, preferably citric acid and/or phosphoric acid, to obtain an oil/water mixture, wherein the oil/water mixture comprises between 0.1 and 5.0 kilograms (kg) acid per 1000 kg of the degummed feedstock;
adjusting the pH of the oil/water mixture to a value between and including 5 and 7;
adjusting the temperature to a value between and including 80 and 100 degrees Celsius (° C.); and
adjusting the absolute pressure to a value between and including 1 and 2.5 bara.

Optionally, the degummed feedstock is contacted with a mixture of hot water and the acid.

Optionally, the first chloride removal conditions comprise subjecting the oil/water mixture to a water washing step to obtain the first dechlorinated feedstock. The washed water outlet from the water washing step is routed to an absorption type purification step to obtain washed water free of any chloride compounds thereafter recycled to the washing step.

Optionally, the degumming step and the first chloride removal step are performed simultaneously and/or in the same vessel.

Optionally, the bleaching conditions comprise:
contacting with a bleaching agent comprising at least one element selected from the group comprising: bleaching earth, silica gel, or filter aid;
filtering off the bleaching agent after contacting to obtain the bleached feedstock; and
optionally adding nitrogen or steam.

Optionally, steam is added during contacting with a bleaching agent for agitation or mixing effect and for stripping off some volatile undesired compounds, if any.

Optionally, nitrogen is added, for example intermittently, to cool down the spent bleaching agent while discharging it.

Optionally, the second chloride removal agent comprises an adsorbent or absorbent, capable of adsorbing or absorbing organic chlorides.

Optionally, the second chloride removal agent comprises at least one element selected from the group comprising: molecular sieve, alumina, silica, activated charcoal/carbon, or molded ceramic bodies, preferably molded ceramic balls.

Optionally, the second chloride removal conditions comprise:
activating the second chloride removal agent at a temperature between and including 100 and 300° C., to obtain an activated second chloride removal agent, prior to contacting with the bleached feedstock;
contacting the bleached feedstock with the activated second chloride removal agent in a batch reactor or a fixed bed reactor;
adjusting the temperature to a value between and including 20 and 100° C.;
adjusting the absolute pressure to a value between and including 1 and 2.5 bara; and
adjusting the space velocity (LHSV) to a value between and including 0.1 and 10 hour\hat{ }−1 (h⁻¹).

Optionally, nitrogen is added, e.g. intermittently, to cool down the spent bleaching earth while discharging it.

Optionally, the chloride concentration in the chloride depleted feedstock equals or is lower than 50 weight (wt.)-parts per million (ppm), preferably equals or is lower than 20 wt.-ppm, most preferably equals or is lower than 10 wt.-ppm.

Optionally, the process comprises a step of subjecting the first dechlorinated feedstock and/or the bleached feedstock to a polyethylene removal step under polyethylene removal conditions to obtain a polyethylene depleted feedstock.

The polyethylene removal conditions may include adding a filter aid chemical to the first dechlorinated feedstock and/or the bleached feedstock and thereafter and filtering out the filter aid chemical with polyethylene to obtain the polyethylene depleted feedstock.

The polyethylene removal step is advantageous as it mitigates plugging problems due to polyethylene in the internals (like in the packings in the columns in downstream section) or in catalysts in the downstream of the HVO plant. Accordingly, the polyethylene removal step reduces maintenance cost and plant shutdown and/or downtime in downstream units.

In an example, exemplary polyethylene conditions comprise:
Cooling of the feed material to the range of 50-70° C. up to the point where plastics are not soluble in oil and high enough to keep the oils & fats in liquid phase;
adding a filter aid, e. g. silica or cellulosic type, e. g. at a rate of 1-15 kg filter aid per ton of feed in order to agglomerate the polyethylene and make it filterable;
homogenizing the mixture under cooled temperature and atmospheric pressure;
removing polyethylene and solids (e.g. filter aid) by filtration using a filter, e. g. a pressure leaf filter.

Optionally, the process comprises a step of subjecting the bleached feedstock and/or the polyethylene depleted feedstock to a free fatty acid (FFA) removal step under free fatty acid (FFA) removal conditions to obtain a free fatty acid depleted feedstock.

The free fatty acid (FFA) removal conditions may include contacting the bleached feedstock and/or the polyethylene depleted feedstock with a free fatty acid (FFA) removal agent.

Optionally, the free fatty acid (FFA) removal step includes at least one of enzymatic esterification, chemical esterification, supercritical extraction, membrane separation, liquid-liquid extraction, or stripping.

The free fatty acid (FFA) removal step removes FFA content from waste oil or used cooking oil, thereby enabling the waste oil or used cooking oil as an effective feedstock for production of the renewable fuel, Consequently, production costs of the renewable fuel are reduced due to a use of the waste oil or used cooking oil as the feedstock.

In an example, the free fatty acid (FFA) removal step comprises treating a feed, e. g. an oil, in a stripper column in a temperature range of 230-260° C. at a vacuum of 0.001-0.008 kg/cm². In an example, the free fatty acid content in the final product is lower than 0.1 wt.-% considering a maximum content of 20 wt.-% FFA in the feed oil.

Optionally, the process comprises a step of subjecting any of the degummed feedstock and/or bleached feedstock and/or the polyethylene depleted feedstock and/or the free fatty acid depleted feedstock to an oil splitting step under oil splitting conditions to obtain an oil split feedstock, wherein the oil splitting conditions comprise contacting with water or steam.

Advantages of the oil splitting step may include improvement of HVO-catalyst lifetime through further removal of impurities, and considerable savings in operating expenditure (OPEX) due to the reduction of hydrogen consumption in the HVO process. The oil splitting step may also provide a valuable by-product, premium glycerin, instead of propane. Glycerin may add further value in terms of producing refined glycerin or green chemicals like Bio Propylene Glycol (Bio-PG) from any existing HVO plant.

In an example, the oil splitting step comprises splitting an oil with water and/or steam into free fatty acids and glycerine at temperatures of 235 to 260° C. and pressures between 40 and 60 kg/cm² inside a splitting column where water and/or steam flow in a counter-current direction relative to the oil flow.

Optionally, the process comprises a step of subjecting any of the bleached feedstock and/or the polyethylene depleted feedstock and/or the free fatty acid depleted feedstock and/or the oil split feedstock to the second chloride removal step to obtain a chloride depleted feedstock by contacting the bleached feedstock with at least one second chloride removal agent under second chloride removal conditions.

The second chloride removal step may preferably remove organic chlorides from the crude oil or fat feedstock.

According to a second aspect, the present disclosure provides a use of the chloride depleted feedstock as feedstock for a hydrotreatment of vegetable oils or fats to obtain a hydrotreated vegetable oil (HVO) or fat product.

The use of the chloride depleted feedstock as feedstock in a HVO plant may significantly reduce the risk of chloride induced stress corrosion cracking in downstream of the HVO plant and consequently a demand for high grade materials for the construction of the HVO plant.

According to a third aspect, the present disclosure provides an apparatus for producing a chloride depleted feedstock from a chloride containing crude oil or fat feedstock, wherein the apparatus comprises:
(a) means for providing the chloride containing crude oil or fat feedstock;
(b) means for subjecting the chloride containing crude oil or fat feedstock to a degumming step to obtain a degummed feedstock by contacting the chloride containing crude oil or fat feedstock with at least one degumming agent under degumming conditions;
(c) means for subjecting the degummed feedstock to a first chloride removal step to obtain a first dechlorinated feedstock by contacting the degummed feedstock with at least one first chloride removal agent under first chloride removal conditions;
(d) means for subjecting the first dechlorinated feedstock to a bleaching step to obtain a bleached feedstock by contacting the first dechlorinated feedstock with at least one bleaching agent under bleaching conditions;
(e) means for subjecting the bleached feedstock to a second chloride removal step to obtain a chloride depleted feedstock by contacting the bleached feedstock with at least one second chloride removal agent under second chloride removal conditions; and
(f) means for routing out the chloride depleted feedstock from the second chloride removal step.

The apparatus for producing the chloride depleted feedstock according to the present disclosure is of advantage in that a minimum of 90% of total chloride compounds including organic chlorides are removed from the chloride containing crude oil or fat feedstock by virtue of the first chloride removal step and the second chloride removal step. Accordingly, the apparatus significantly alleviates the risk of chloride induced stress corrosion cracking in downstream of a hydrotreating vegetable oils (HVO) plant. Further, the apparatus reduces investment costs due to high-grade construction material, like stainless steel or nickel-based alloys, for the HVO plant or part of internals, as the high-grade construction material is required for the HVO plant to process the feedstocks with high chloride content.

Below table illustrates an example showing an evolution of chloride removal along the HVO pretreatment process steps including the first chloride removal step and the second chloride removal step according to the present disclosure:

| | | Ultra- | | |
|---|---|---|---|---|
| | | degummed | Bleached | Adsorbed |
| | Feedstock | oil | oil | oil |
| Total chloride Content | 399 | 62 | 23 | 10 |
| one specific case | | | | |
| (wt.-ppm) | | | | |
| Total chloride Content | 150-400 | 30-60 | 10-25 | 1-10 |
| Typical range | | | | |
| (wt.-ppm) | | | | |

Embodiments of the present disclosure substantially eliminate or at least partially address the aforementioned technical drawbacks in existing technologies by providing two-step chloride removal process steps as part of an overall oil pretreatment or refining process steps that produce the chloride depleted feedstock for the production of renewable fuels.

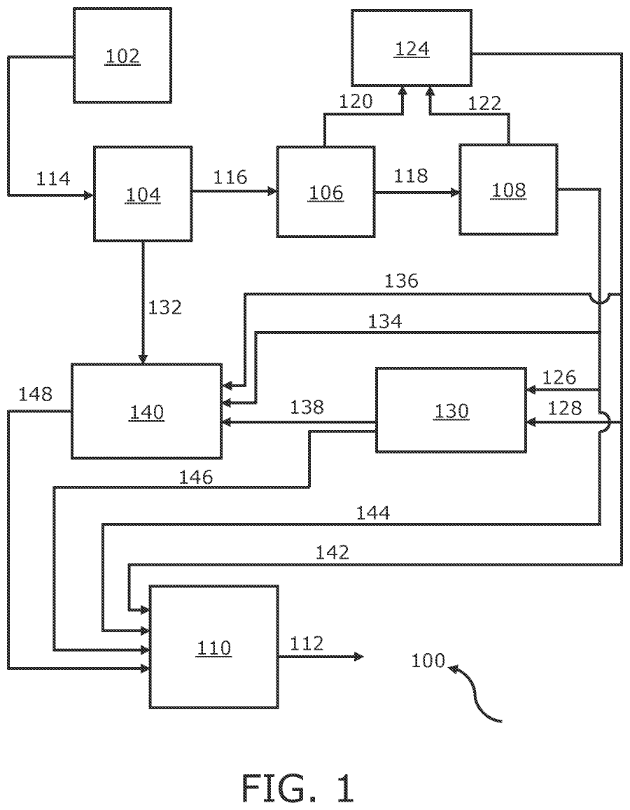

FIG. 1 is a block diagram of an apparatus 100 or a flow diagram of a process 100 for producing a chloride depleted feedstock from a chloride containing crude oil or fat feedstock according to an embodiment of the present disclosure. The apparatus 100 includes a feedstock means 102, a degumming means 104, a first chloride removal means 106, a bleaching means 108, a second chloride removal means 110, and one or more routing means 112-122, 126-128, 132-138 and 142-148. The feedstock means 102 is configured to provide the chloride containing crude oil or fat feedstock to the degumming means 104 via the routing means 114. The feedstock may comprise organic and inorganic chlorides. The degumming means 104 is configured to subject the chloride containing crude oil or fat feedstock to a degumming step to obtain a degummed feedstock by contacting the chloride containing crude oil or fat feedstock with at least one degumming agent under degumming conditions.

The first chloride removal means 106 is configured to receive the degummed feedstock from the degumming means 104 via the routing means 116 and subject the degummed feedstock to a first chloride removal step to obtain a first dechlorinated feedstock by contacting the degummed feedstock with at least one first chloride removal agent under first chloride removal conditions. The first chloride removal conditions include (i) contacting the degummed feedstock with a mixture of water and an acid, preferably citric acid and/or phosphoric acid, to obtain an oil/water mixture, (ii) adjusting the pH of the oil/water mixture to a value between and including 5 and 7, (iii) adjusting the temperature to a value between and including 80 and 100° C.; and (iv) adjusting the absolute pressure to a value between and including 1 and 2.5 bara. The oil/water mixture includes between 0.1 and 5.0 kilograms (kg) acid per 1000 kg of the degummed feedstock.

The bleaching means 108 is configured to receive the first dechlorinated feedstock from the first chloride removal means 106 via the routing means 118 and subject the first dechlorinated feedstock to a bleaching step to obtain a bleached feedstock by contacting the first dechlorinated feedstock with at least one bleaching agent under bleaching conditions. The bleaching conditions include (i) contacting with a bleaching agent including at least one element selected from the group including: bleaching earth, silica gel, or filter aid, (ii) filtering off the bleaching agent after contacting to obtain the bleached feedstock; and (iii) optionally adding nitrogen or steam. Optionally, steam is added during contacting with a bleaching agent for agitation or mixing effect and for stripping off some volatile undesired compounds, if any. Optionally, nitrogen is added, for example intermittently, to cool down the spent bleaching agent while discharging it.

The second chloride removal means 110 is configured to receive the bleached feedstock from the bleaching means 108 via the routing means 144 and subject the bleached feedstock to a second chloride removal step to obtain the chloride depleted feedstock by contacting the bleached feedstock with at least one second chloride removal agent under second chloride removal conditions. The second chloride removal conditions include (i) activating the second chloride removal agent at a temperature between and including 100 and 300° C., to obtain an activated second chloride removal agent, prior to contacting with the bleached feedstock, (ii) contacting the bleached feedstock with the activated second chloride removal agent in a batch reactor or a fixed bed reactor, (iii) adjusting the temperature to a value between and including 20 and 100° C., (iv) adjusting the absolute pressure to a value between and including 1 and 2.5 bara; and (v) adjusting the space velocity (LHSV) to a value between and including 0.1 and 10 hour\hat{ }−1 (h⁻¹). The routing means 112 is configured to rout out the chloride depleted feedstock from the second chloride removal step.

The apparatus 100 optionally includes a polyethylene (PE) removal means 124, a free fatty acid (FFA) removal means 130, and an oil splitting means 140.

The polyethylene (PE) removal means 124 is configured to receive the first dechlorinated feedstock and/or the bleached feedstock from the first chlorine removal means 106 and/or the bleaching means 108 via the routing means 120 and/or 122 respectively and subject the first dechlorinated feedstock and/or the bleached feedstock to a polyethylene removal step under polyethylene removal conditions to obtain a polyethylene depleted feedstock.

The free fatty acid (FFA) removal means 130 is configured to receive the bleached feedstock and/or the polyethylene depleted feedstock from the bleaching means 108 and/or the polyethylene (PE) removal means 124 via the routing means 126 and/or 128 respectively and subject the bleached feedstock and/or the polyethylene depleted feedstock to a free fatty acid (FFA) removal step under free fatty acid (FFA) removal conditions to obtain a free fatty acid depleted feedstock.

The oil splitting means 140 is configured to receive any of the degummed feedstock and/or bleached feedstock and/or the polyethylene depleted feedstock and/or the free fatty acid depleted feedstock from the degummed feedstock and/or bleached feedstock and/or the polyethylene depleted feedstock and/or the free fatty acid depleted feedstock from the degumming means 104 and/or the bleaching means 108 and/or the polyethylene (PE) removal means 124 and/or the free fatty acid (FFA) removal means 130 via the routing means 132 and/or 134 and/or 136 and/or 138 respectively. The oil splitting means 140 is further configured to subject any of the degummed feedstock and/or bleached feedstock and/or the polyethylene depleted feedstock and/or the free fatty acid depleted feedstock to an oil splitting step under oil splitting conditions to obtain an oil split feedstock. The oil splitting conditions comprise contacting any of the degummed feedstock and/or bleached feedstock and/or the polyethylene depleted feedstock and/or the free fatty acid depleted feedstock with water or steam.

The second chloride removal means 110 is configured to receive any of the bleached feedstock and/or the polyethylene depleted feedstock and/or the free fatty acid depleted feedstock and/or the oil split feedstock from the bleaching means 108 and/or the polyethylene (PE) removal means 124 and/or the free fatty acid (FFA) removal means 130 and/or the oil splitting means 140 via the routing means 144 and/or 142 and/or 146 and/or 148 respectively. The second chloride removal means 110 is further configured to subject any of the bleached feedstock and/or the polyethylene depleted feedstock and/or the free fatty acid depleted feedstock and/or the oil split feedstock to the second chloride removal step to obtain a chloride depleted feedstock by contacting the bleached feedstock with at least one second chloride removal agent under second chloride removal conditions.

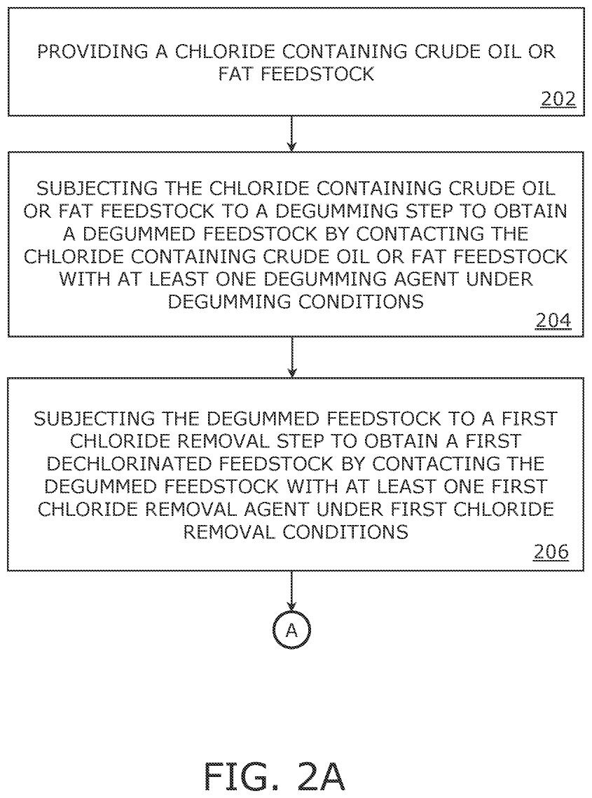

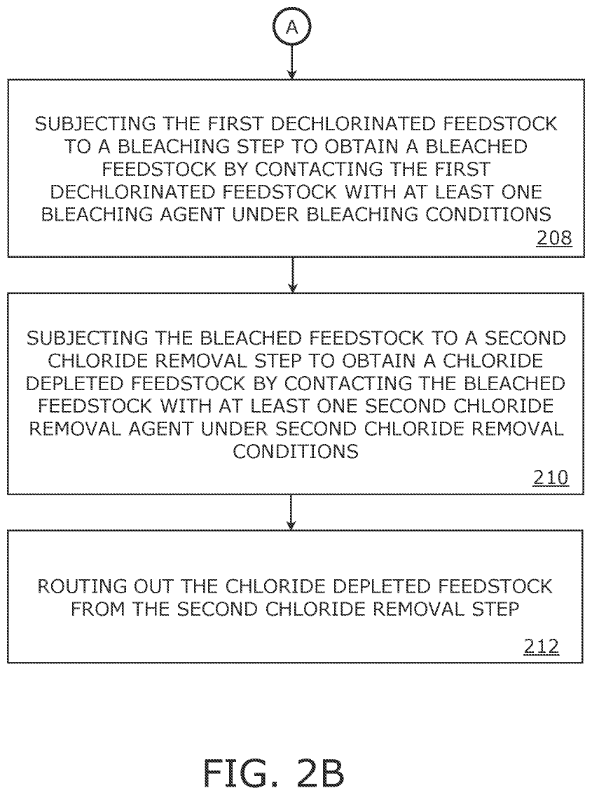

FIGS. 2A and 2B are flowcharts illustrating a process for producing a chloride depleted feedstock from a chloride containing crude oil or fat feedstock according to an embodiment of the present disclosure. At a step 202, the chloride containing crude oil or fat feedstock is provided. At a step 204, the chloride containing crude oil or fat feedstock is subjected to a degumming step to obtain a degummed feedstock by contacting the chloride containing crude oil or fat feedstock with at least one degumming agent under degumming conditions. At a step 206, the degummed feedstock is subjected to a first chloride removal step to obtain a first dechlorinated feedstock by contacting the degummed feedstock with at least one first chloride removal agent under first chloride removal conditions. At a step 208, the first dechlorinated feedstock is subjected to a bleaching step to obtain a bleached feedstock by contacting the first dechlorinated feedstock with at least one bleaching agent under bleaching conditions. At a step 210, the bleached feedstock is subjected to a second chloride removal step to obtain a chloride depleted feedstock by contacting the bleached feedstock with at least one second chloride removal agent under second chloride removal conditions. At a step 212, the chloride depleted feedstock is routed out from the second chloride removal step.

The conditions required for performing the following standard oil or fat processing operations: degumming, bleaching, free fatty acid (FFA) removal, oil splitting, polyethylene removal, are known to the skilled person from the prior art. These are the physicochemical conditions under which a measurable, at least partial, preferably an industrially relevant, conversion of a crude oil or fat the corresponding processed oil or fat product is achieved. Necessary adjustments of these processing conditions to the respective operational requirements will be made on the basis of routine experiments. Any specific reaction conditions disclosed may serve here as a guide, but they should not be regarded as limiting in relation to the scope of the invention.

The first or second chloride removal conditions are disclosed in the claims and description of this specification in a specific fashion. However, the skilled person is capable to conceive modifications of these specific conditions, if required, e. g. by routine experiments.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural.

### LIST OF REFERENCE NUMERALS

100—Apparatus
102—Feedstock means
104 Degumming means
106—First chloride removal means
108—Bleaching means
110—Second chloride removal means
112 to 122—Routing means
124—Polyethylene (PE) removal means
126 to 128—Routing means
130—Free fatty acid (FFA) removal means
132 to 138—Routing means
140—Oil splitting means
142 to 148—Routing means

What is claimed is:

1. A process for producing a chloride depleted feedstock from a chloride containing crude oil or fat feedstock, the process comprising:
(a) providing the chloride containing crude oil or fat feedstock;
(b) subjecting the chloride containing crude oil or fat feedstock to a degumming step to obtain a degummed feedstock by contacting the chloride containing crude oil or fat feedstock with at least one degumming agent under degumming conditions;
(c) subjecting the degummed feedstock to a first chloride removal step to obtain a first dechlorinated feedstock by contacting the degummed feedstock with at least one first chloride removal agent under first chloride removal conditions;
(d) subjecting the first dechlorinated feedstock to a bleaching step to obtain a bleached feedstock by contacting the first dechlorinated feedstock with at least one bleaching agent under bleaching conditions;
(e) subjecting the bleached feedstock to a second chloride removal step to obtain a chloride depleted feedstock by contacting the bleached feedstock with at least one second chloride removal agent under second chloride removal conditions; and
(f) routing out the chloride depleted feedstock from the second chloride removal step.

2. The process according to claim 1, wherein the chloride containing crude oil or fat feedstock comprises at least one element selected from the group consisting of:
natural oils and fats, waste oils and fats, pretreated oils and fats, cooking oil, tallow, palm oil mill effluent, palm oil fatty acid distillate, and tall oil.

3. The process according to claim 1, wherein the degumming agent comprises at least one element selected from the group consisting of:
an acid agent, preferably citric and/or phosphoric acid; a basic agent, preferably caustic soda; and water.

4. The process according to claim 1, wherein the first chloride removal agent comprises at least one element selected from the group consisting of:
an acid agent, preferably citric and/or phosphoric acid; a basic agent, preferably caustic soda; and water.

5. The process according to claim 1, wherein the first chloride removal conditions comprise:
contacting the degummed feedstock with a mixture of water and an acid to obtain an oil/water mixture, wherein the oil/water mixture comprises between 0.1 and 5.0 kilograms (kg) acid per 1000 kg of the degummed feedstock;
adjusting the pH of the oil/water mixture to a value between and including 5 and 7;
adjusting the temperature to a value between and including 80 and 100 degrees Celsius (° C.); and
adjusting the absolute pressure to a value between and including 1 and 2.5 bara.

6. The process according to claim 1, wherein the degumming step and the first chloride removal step are performed simultaneously and/or in the same vessel.

7. The process according to claim 1, wherein the bleaching conditions comprise:
contacting with a bleaching agent comprising at least one element selected from the group consisting of: bleaching earth, silica gel, and filter aid;
filtering off the bleaching agent after contacting to obtain the bleached feedstock; and
adding nitrogen or steam.

8. The process according to claim 1, wherein the second chloride removal agent comprises an adsorbent or absorbent, capable of adsorbing or absorbing organic chlorides.

9. The process according to claim 8, wherein the second chloride removal agent comprises at least one element selected from the group consisting of:
molecular sieve, alumina, silica, activated charcoal/carbon, and molded ceramic bodies.

10. The process according to claim 1, wherein the second chloride removal conditions comprise;
activating the second chloride removal agent at a temperature between and including 100 and 300° C., to obtain an activated second chloride removal agent, prior to contacting with the bleached feedstock;
contacting the bleached feedstock with the activated second chloride removal agent in a batch reactor or a fixed bed reactor;
adjusting the temperature to a value between and including 20 and 100° C.;
adjusting the absolute pressure to a value between and including 1 and 2.5 bara; and
adjusting the space velocity (LHSV) to a value between and including 0.1 and 10 hour\hat{ }−1 (h⁻¹).

11. The process according to claim 1, wherein the chloride concentration in the chloride depleted feedstock equals or is lower than 50 weight (wt.)-parts per million (ppm).

12. The process according to claim 1, wherein the process comprises a step of subjecting the first dechlorinated feedstock and/or the bleached feedstock to a polyethylene removal step under polyethylene removal conditions to obtain a polyethylene depleted feedstock.

13. The process according to claim 1, further comprising of subjecting the bleached feedstock and/or the polyethylene depleted feedstock to a free fatty acid (FFA) removal step under free fatty acid (FFA) removal conditions to obtain a free fatty acid depleted feedstock.

14. The process according to claim 1, further comprising subjecting any of the degummed feedstock and/or bleached feedstock and/or the polyethylene depleted feedstock and/or the free fatty acid depleted feedstock to an oil splitting step under oil splitting conditions to obtain an oil split feedstock, wherein the oil splitting conditions comprise contacting with water or steam.

15. The process according to claim 1, further comprising subjecting any of the bleached feedstock and/or the polyethylene depleted feedstock and/or the free fatty acid depleted feedstock and/or the oil split feedstock to the second chloride removal step to obtain a chloride depleted feedstock by contacting the bleached feedstock with at least one second chloride removal agent under second chloride removal conditions.

17. An apparatus for producing a chloride depleted feedstock from a chloride containing crude oil or fat feedstock, the apparatus comprising:
(a) a means for providing the chloride containing crude oil or fat feedstock;
(b) a means for subjecting the chloride containing crude oil or fat feedstock to a degumming step to obtain a degummed feedstock by contacting the chloride containing crude oil or fat feedstock with at least one degumming agent under degumming conditions;
(c) a means for subjecting the degummed feedstock to a first chloride removal step to obtain a first dechlorinated feedstock by contacting the degummed feedstock with at least one first chloride removal agent under first chloride removal conditions;
(d) a means for subjecting the first dechlorinated feedstock to a bleaching step to obtain a bleached feedstock by contacting the first dechlorinated feedstock with at least one bleaching agent under bleaching conditions;
(e) a means for subjecting the bleached feedstock to a second chloride removal step to obtain a chloride depleted feedstock by contacting the bleached feedstock with at least one second chloride removal agent under second chloride removal conditions; and
(f) a means for routing out the chloride depleted feedstock from the second chloride removal step.
